(19) United States
(12) Patent Application Publication
(10) Pub. No.: US 2007/0222627 A1
(43) Pub. Date: Sep. 27, 2007

(54) Lamp apparatus with alarm function

(75) Inventors: Dong-Liang Chen, Sansia Township (TW); Jung-Chien Chang, Tayuan Township (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 11/476,159

(22) Filed: Jun. 28, 2006

(30) Foreign Application Priority Data
Mar. 21, 2006 (TW) 095109614

(51) Int. Cl. G08B 17/10

(52) U.S. Cl. 340/632

(57) ABSTRACT

A lamp apparatus with an alarm function is disclosed, which includes a power supply circuit and a base, and a light and a gas warning apparatus mounted on the base. The gas warning apparatus comprises an alarm device and a gas sensor. The gas sensor transmits an actuating signal to the alarm device for triggering the alarm device to actuate an alarm correspondingly when the gas sensor detects a hazardous gas. Therefore, the gas warning apparatus mounted within the lamp not only uses the power of the lamp for supplying the necessary power continuously but also eliminates unsightly other wiring.

### BACKGROUND OF THE INVENTION

1. Field of the Invention

The present invention relates to a lamp apparatus with alarm function and, more particularly, to a lamp apparatus with an alarm function for detecting a hazardous gas.

2. Description of Related Art

Throughout the world, people use devices for heating and cooking which are often powered by combustible gas. Though extremely useful, those devices may also cause a hazard to human life through the emission of unburned gas, toxic fumes, etc. In order to avoid the occurrence of the above accidents, all sorts of the alarm devices such as gas alarms or a smoke alarms are available on the market. However, those gas alarm devices must be mounted in the bathroom, on the ceiling of the kitchen, etc. The gas alarm devices also need to have a power cord for supplying the necessary electrical power continuously which is inconvenient and detrimental to the interior design.

Therefore, it is desirable to provide a lamp apparatus with an alarm function to mitigate and/or obviate the aforementioned problems.

### SUMMARY OF THE INVENTION

The present invention provides a lamp apparatus with an alarm function, which comprises a base, a power supply circuit, a light, and a gas warning apparatus. A power switch is mounted as a total power switch inside the power supply circuit.

The light is mounted on the base and includes a light switch. The light switch is electrically connected to the power supply circuit for switching the light between on an electric conduction and a dielectric conduction.

Further, the gas warning apparatus is also mounted on the base and is electrically connected to the power supply circuit. The gas warning apparatus comprises an alarm device and a gas sensor. The gas sensor transmits an actuating signal to the alarm device for triggering the alarm device to actuate an alarm correspondingly such as light or the sound when the gas sensor detects a hazardous gas.

Therefore, the gas warning apparatus of the present invention inside the lamp not only uses the power of the lamp for supplying the necessary power continuously but also does not need an electric cord, thus avoiding unsightly features. The gas sensor of the present invention detects the hazardous gas that may be carbon monoxide, or a natural gas, or a thick smoke, or other harmful gases.

The alarm device of the present invention may be a buzzer, a warning lamp, or other equivalent alarm devices.

The light of the present invention may be a circular light, a light bulb, or a linear fluorescent tube, or other equivalent lights due to the place of the different installation.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of the present invention.

FIG. 2 is a schematic view of a lamp apparatus with an alarm function in accordance with a first embodiment of the present invention.

FIG. 3 is a schematic view of a lamp apparatus with an alarm function in accordance with a second embodiment of the present invention.

FIG. 4 is a schematic view of a lamp apparatus with an alarm function in accordance with a third embodiment of the present invention.

### DETAILED DESCRIPTION OF THE PREFERRED EMBODIMENT

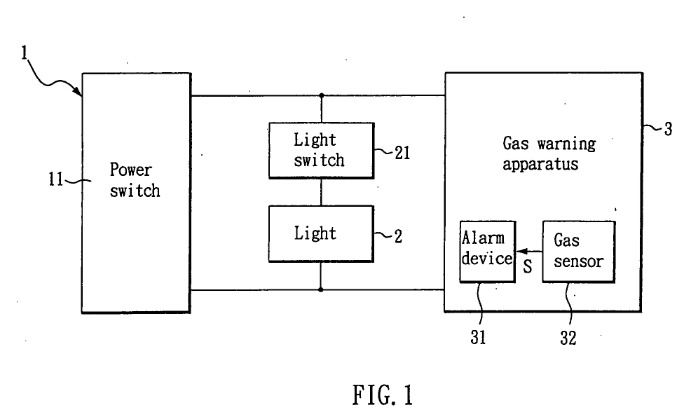

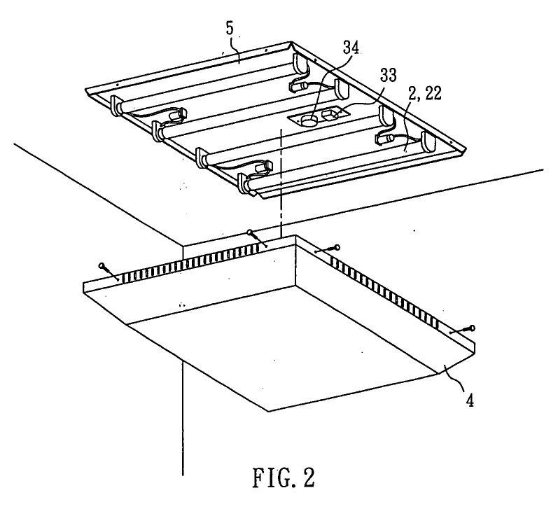

FIG. 1 is a block diagram of the present invention and FIG. 2 is a schematic view of a lamp apparatus with alarm function in accordance with a first embodiment of the present invention. As shown in FIG. 1, the present invention comprises a power supply circuit 1, a light 2, and a gas warning apparatus 3.

The power supply circuit 1 has a power switch 11 for switching the whole power supply circuit 1 between on an electric conduction and a dielectric conduction. The light 2 is electrically connected to the power supply circuit 1 by a light switch 21 for switching the light 2 between the electric conduction and the dielectric conduction. The gas warning apparatus 3 is electrically connected to the power supply circuit 1. The gas warning apparatus 3 comprises an alarm device 31 and a gas sensor 32. The gas sensor 32 transmits an actuating signal S to the alarm device 31 for triggering the alarm device 31 to actuate an alarm correspondingly such as a warning light or a warning sound when the gas sensor 32 detects a hazardous gas.

As shown in FIG. 2, in this embodiment, the light 2 is a fluorescent tube 22 (four are shown here) and is mounted on a base 5. The gas warning apparatus 3 is composed of an alarm device 33 and a gas sensor 34 and is mounted on the base 5. After the light 2 and the gas warning apparatus 3 are mounted on the base 5, a lampshade 4 is fitted to the base 5 for enhancing the esthetic sensibilities and protecting the internal components.

Therefore, the present invention fabricates the fluorescent tube 22 with the gas warning apparatus 3 such that it that not only uses the power supply of the fluorescent tube 22 for supplying the necessary power continuously but also eliminates the need for an external electric cord, thereby avoiding unsightly features. In addition, the gas warning apparatus 3 is mounted on the ceiling with the fluorescent tube 22 for improving sensitivity of detection of the pernicious gases.

Furthermore, according to the users' demands and cost considerations, the gas sensor 34 can be a carbon monoxide sensor, a natural gas sensor, a thick smoke sensor, or a multi-function compound gas sensor for automatically detecting a variety of hazardous situations. Also, the alarm device 33 can be a buzzer, a warning lamp, or other alarm devices.

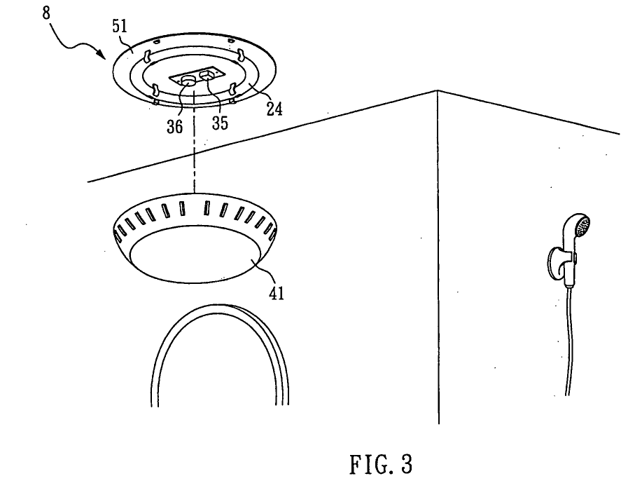

FIG. 3 is a schematic view of a lamp apparatus with an alarm function in accordance with a second embodiment of the present invention. The structure of this embodiment is similar to the foregoing example, but the different point is a place of the installation. As shown in FIG. 3, a bathroom lamp 8 is mounted on the bathroom ceiling and has a base 51. An annular fluorescent light 24, an alarm device 35, and a gas sensor 36 are mounted on the base 51 respectively and the outer base is covered a lampshade 41.

Therefore, when a user is taking a shower the gas sensor 36 can detect the density of natural gases, carbon monoxide, etc and determine whether the atmosphere is maintained within a range sufficiently safe for avoiding casualty.

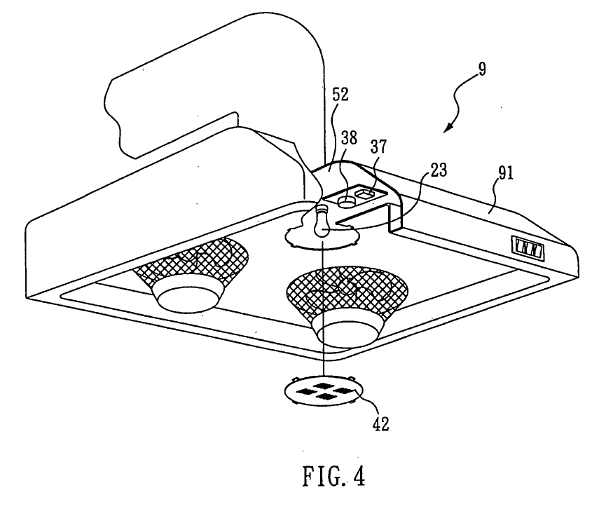

FIG. 4 is a schematic view of a lamp apparatus with an alarm function in accordance with a third embodiment of the present invention. The structure of this embodiment is similar to the first embodiment, but the different point is a place of the installation. This embodiment applies to a cooker hood 91 in the kitchen.

As shown in FIG. 4, an internal lamp apparatus 9 is mounted on a shell 52 of the cooker hood 91. The lamp apparatus 9 comprises a light bulb 23, an alarm device 37, and a gas sensor 38 and the outside of the lamp apparatus 9 is covered with sheathing 42 pervious to light.

Therefore, when a user is cooking in the kitchen the gas sensor 38 of the lamp apparatus 9 can detect the density of the natural gas, carbon monoxide, etc for avoiding casualty.

Although the present invention has been explained in relation to its preferred embodiment, it is to be understood that many other possible modifications and variations can be made without departing from the scope of the invention as hereinafter claimed.

What is claimed is:

1. A lamp apparatus with an alarm function, comprising:
a base;
a power supply circuit comprising a power switch thereof;
a light mounted on said base, said light comprising a light switch thereof electrically connected between said power supply circuit and said light; and
a gas warning apparatus mounted on said base and electrically connected to said power supply circuit, said gas warning apparatus comprising an alarm device and a gas sensor, said gas sensor transmitting an actuating signal to said alarm device for triggering said alarm device to actuate an alarm correspondingly when said gas sensor detects a hazardous gas.

2. The lamp apparatus with an alarm function as claimed in claim 1, wherein said hazardous gas is carbon monoxide, a natural gas, or thick smoke.

3. The lamp apparatus with an alarm function as claimed in claim 1, wherein said alarm device is selected from at least one of a group of a buzzer, and a warning lamp.

4. The lamp apparatus with an alarm function as claimed in claim 1, further comprising a lampshade for covering said light.

5. The lamp apparatus with an alarm function as claimed in claim 1, wherein said lamp apparatus is a bathroom lamp.

6. The lamp apparatus with an alarm function as claimed in claim 5, wherein said light is an annular fluorescent tube.

7. The lamp apparatus with alarm function as claimed in claim 1, wherein said lamp apparatus is a lamp of a cooker hood.

8. The lamp apparatus with an alarm function as claimed in claim 7, wherein said light is a light bulb.
